(19) United States
(12) Patent Application Publication
(10) Pub. No.: US 2013/0221911 A1
(43) Pub. Date: Aug. 29, 2013

(54) SYSTEMS AND METHODS FOR SENSING REVERSE LINK SIGNALING

(71) Applicants: Zhen Ning Low, San Diego, CA (US); Charles E. Wheatley, San Diego, CA (US)

(72) Inventors: Zhen Ning Low, San Diego, CA (US); Charles E. Wheatley, San Diego, CA (US)

(73) Assignee: QUALCOMM INCORPORATED, San Diego, CA (US)

(21) Appl. No.: 13/624,295

(22) Filed: Sep. 21, 2012

Related U.S. Application Data
(60) Provisional application No. 61/604,447, filed on Feb. 28, 2012.

(51) Int. Cl. H01F 38/14; H02J 17/00; H02J 7/00

(52) U.S. Cl. CPC H01F 38/14; H02J 7/007; H02J 17/00
USPC 320/108; 307/104

(57) ABSTRACT

Systems and methods for sensing reverse link signaling are described herein. In one aspect, an apparatus for wireless transmission includes a push-pull driver circuit, coil, and sensor. The push-pull driver circuit is configured to generate a signal. The coil is electrically coupled to the push-pull driver circuit, and the coil is configured to receive the signal from the push-pull driver circuit and wirelessly transmit the signal to a receiver. The sensor is electrically coupled to a virtual alternating current (AC) ground of the push-pull driver circuit or the coil. The sensor is configured to sense a shift in voltage at the virtual AC ground where the shift in voltage is representative of a change of an input impedance of the receiver.

### CROSS REFERENCE TO RELATED APPLICATIONS

This application claims benefit under 35 U.S.C. §119(e) to U.S. Provisional Patent Application No. 61/604,447 entitled “SYSTEMS AND METHODS FOR SENSING REVERSE LINK SIGNALING” filed on Feb. 28, 2012; the disclosure of which is hereby incorporated by reference in its entirety.

### FIELD

The present disclosure relates generally to wireless communications. More specifically, the present disclosure relates to systems and methods for sensing reverse link signaling.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power. As such, these devices constantly require recharging. Rechargeable devices are often charged via wired connections through cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices or provide power to electronic devices may overcome some of the deficiencies of wired charging solutions.

In some cases, a wireless power receiving device may communicate with a wireless power transmitting device via modulation or changing of a load connected to the wireless power receiving device. This communication may be referred to as “reverse link signaling.”

### SUMMARY

Sensing reverse link signaling at a wireless power transmitting device may necessitate complex circuitry, require sufficient time to determine that a signal has been received, and interfere with performance of the wireless power transmitting device. Accordingly, improved systems and methods for sensing reverse link signaling are desired.

Thus, one aspect of the disclosure provides an apparatus for wireless power transmission including a push-pull driver circuit, a coil, and a sensor. The push-pull driver circuit is configured to generate a signal. The coil is electrically coupled to the push-pull driver circuit. The coil is configured to receive the signal from the push-pull driver circuit and wirelessly transmit the signal to a receiver. The sensor is electrically coupled to a virtual alternating current (AC) ground of the push-pull driver circuit or the coil. The sensor is configured to sense a shift in voltage at the virtual AC ground, where the shift in voltage is representative of a change of an input impedance of the receiver.

Another aspect of the disclosure provides a method of wireless power transmission including: generating a signal with a push-pull driver circuit; transmitting wirelessly with a coil the signal to a receiver; and sensing with a sensor a shift in voltage at a virtual AC ground of the push-pull driver circuit or the coil, where the shift in voltage is representative of a change of an input impedance of the receiver.

One aspect of the disclosure provides an apparatus for wireless power transmission including: means for generating a signal; means for transmitting wirelessly the to a receiver; and means for sensing a shift in voltage at a virtual AC ground of the means for generating or the means for transmitting, where the shift in voltage is representative of a change of an input impedance of the receiver.

Another aspect of the disclosure provides a non-transitory computer storage that stores executable program instructions that direct a wireless power transmitter to perform a process that includes: generating a signal with a push-pull driver circuit to cause a coil to wirelessly transmit the signal to a receiver; and sensing with a sensor a shift in voltage at a virtual AC ground of the push-pull driver circuit or the coil, where the shift in voltage is representative of a change of an input impedance of the receiver.

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a functional block diagram of an example wireless power transfer system.

FIG. 2 is a functional block diagram of example components that may be used in the wireless power transfer system of FIG. 1.

FIG. 3 is a schematic diagram of a portion of transmit circuitry or receive circuitry of FIG. 2 including a transmit or receive coil.

FIG. 4 is a functional block diagram of a transmitter that may be used in the wireless power transfer system of FIG. 1.

FIG. 5 illustrates an example wireless power transfer system including a transmitter and a receiver.

FIG. 6A illustrates an example receiver in a receiving state.

FIG. 6B illustrates another example receiver in another receive state.

FIG. 7 illustrates an example wireless power transfer system including a transmitter and a receiver.

FIG. 8A is a functional block diagram of an example transmitter.

FIG. 8B is an example transmitter driver circuit schematic.

FIG. 9 is a functional block diagram of an example sensor.

FIG. 10 is an example transmitter and sensor circuit schematic.

FIG. 11 is a graph illustrating voltages in an example transmitter and sensor circuit.

FIG. 12 is a flowchart of an example method of sensing reverse link signaling.

FIG. 13 is a functional block diagram of a wireless transmitter configured to sense reverse link signaling.

### DETAILED DESCRIPTION

The detailed description set forth below in connection with the appended drawings is intended as a description of exemplary embodiments of the invention and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. The exemplary embodiments of the invention may be practiced without these specific details. In some instances, well-known structures and devices are shown in block diagram form in order to avoid obscuring the novelty of the exemplary embodiments presented herein.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer.

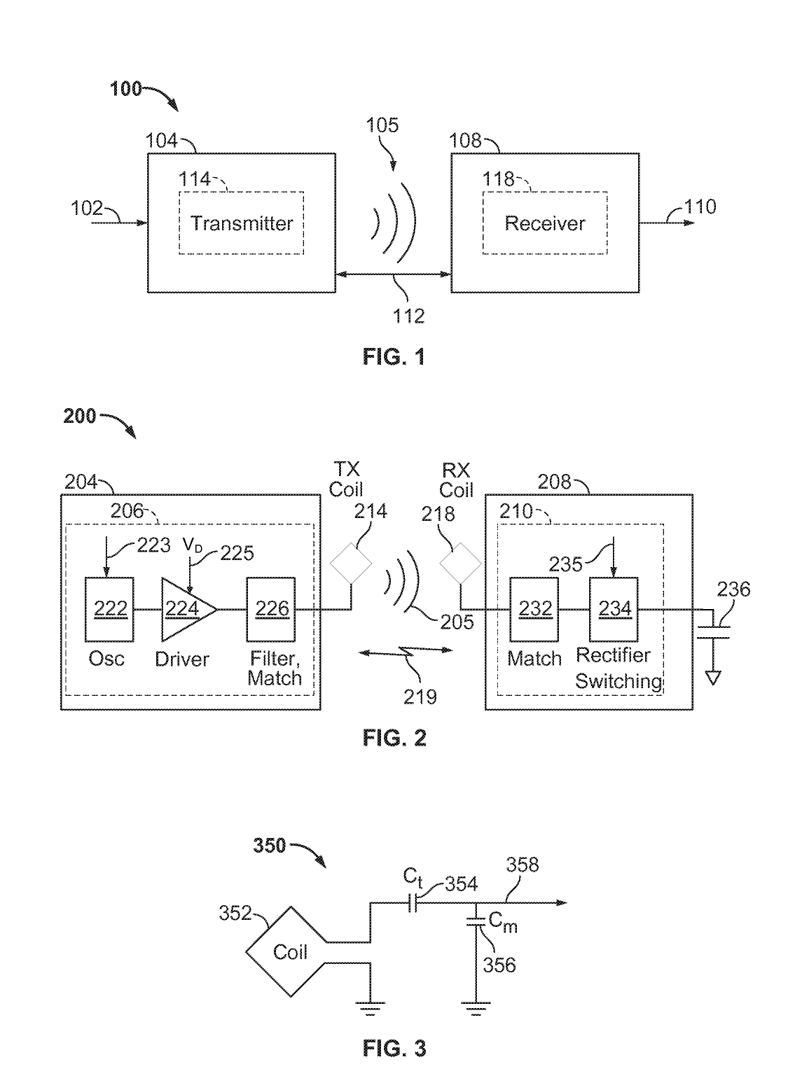

FIG. 1 is a functional block diagram of an exemplary wireless power transfer system 100, in accordance with exemplary embodiments of the invention. Input power 102 may be provided to a transmitter 104 from a power source (not shown) for generating a field 105 for providing energy transfer. The generated field 105 may provide for transfer of energy at a level sufficient to power or charge a device. A receiver 108 may couple to the field 105 and generate output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship. When the resonant frequency of receiver 108 and the resonant frequency of transmitter 104 are substantially the same or very close, transmission losses between the transmitter 104 and the receiver 108 are minimal. As such, wireless power transfer may be provided over larger distance in contrast to purely inductive solutions that may require large coils that require coils to be very close (e.g., mms). Resonant inductive coupling techniques may thus allow for improved efficiency and power transfer over various distances and with a variety of inductive coil configurations.

The receiver 108 may receive power when the receiver 108 is located in an energy field 105 produced by the transmitter 104. The field 105 corresponds to a region where energy output by the transmitter 104 may be captured by a receiver 105. In some cases, the field 105 may correspond to the “near-field” of the transmitter 104 as will be further described below. The transmitter 104 may include a transmit coil 114 for outputting an energy transmission. The receiver 108 further includes a receive coil 118 for receiving or capturing energy from the energy transmission. The near-field may correspond to a region in which there are strong reactive fields resulting from the currents and charges in the transmit coil 114 that minimally radiate power away from the transmit coil 114. In some cases the near-field may correspond to a region that is within about one wavelength (or a fraction thereof) of the transmit coil 114. The transmit and receive coils 114 and 118 are sized according to applications and devices to be associated therewith. As described above, efficient energy transfer may occur by coupling a large portion of the energy in a field 105 of the transmit coil 114 to a receive coil 118 rather than propagating most of the energy in an electromagnetic wave to the far field. When positioned within the field 105, a “coupling mode” may be developed between the transmit coil 114 and the receive coil 118. The area around the transmit and receive coils 114 and 118 where this coupling may occur is referred to herein as a coupling-mode region.

FIG. 2 is a functional block diagram of exemplary components that may be used in the wireless power transfer system 100 of FIG. 1, in accordance with various exemplary embodiments of the invention. The transmitter 204 may include transmit circuitry 206 that may include an oscillator 222, a driver circuit 224, and a filter and matching circuit 226. The oscillator 222 may be configured to generate a signal at a desired frequency, such as 468.75 KHz, 6.78 MHz or 13.56 MHz, that may be adjusted in response to a frequency control signal 223. The oscillator signal may be provided to a driver circuit 224 configured to drive the transmit coil 214 at, for example, a resonant frequency of the transmit coil 214. The driver circuit 224 may be a switching amplifier configured to receive a square wave from the oscillator 222 and output a sine wave. For example, the driver circuit 224 may be a class E amplifier. A filter and matching circuit 226 may be also included to filter out harmonics or other unwanted frequencies and match the impedance of the transmitter 204 to the transmit coil 214.

The receiver 208 may include receive circuitry 210 that may include a matching circuit 232 and a rectifier and switching circuit 234 to generate a DC power output from an AC power input to charge a battery 236 as shown in FIG. 2 or to power a device (not shown) coupled to the receiver 108. The matching circuit 232 may be included to match the impedance of the receive circuitry 210 to the receive coil 218. The receiver 208 and transmitter 204 may additionally communicate on a separate communication channel 219 (e.g., Bluetooth, zigbee, cellular, etc). The receiver 208 and transmitter 204 may alternatively communicate via in-band signaling using characteristics of the wireless field 206.

As described more fully below, receiver 208, that may initially have a selectively disablable associated load (e.g., battery 236), may be configured to determine whether an amount of power transmitted by transmitter 204 and receiver by receiver 208 is appropriate for charging a battery 236. Further, receiver 208 may be configured to enable a load (e.g., battery 236) upon determining that the amount of power is appropriate. In some embodiments, a receiver 208 may be configured to directly utilize power received from a wireless power transfer field without charging of a battery 236. For example, a communication device, such as a near-field communication (NFC) or radio-frequency identification device (RFID) may be configured to receive power from a wireless power transfer field and communicate by interacting with the wireless power transfer field and/or utilize the received power to communicate with a transmitter 204 or other devices.

FIG. 3 is a schematic diagram of a portion of transmit circuitry 206 or receive circuitry 210 of FIG. 2 including a transmit or receive coil 352, in accordance with exemplary embodiments of the invention. As illustrated in FIG. 3, transmit or receive circuitry 350 used in exemplary embodiments may include a coil 352. The coil may also be referred to or be configured as a “loop” antenna 352. The coil 352 may also be referred to herein or be configured as a “magnetic” antenna or an induction coil. The term “coil” is intended to refer to a component that may wirelessly output or receive energy for coupling to another “coil.” The coil may also be referred to as an “antenna” of a type that is configured to wirelessly output or receive power. The coil 352 may be configured to include an air core or a physical core such as a ferrite core (not shown). Air core loop coils may be more tolerable to extraneous physical devices placed in the vicinity of the core. Furthermore, an air core loop coil 352 allows the placement of other components within the core area. In addition, an air core loop may more readily enable placement of the receive coil 218 (FIG. 2) within a plane of the transmit coil 214 (FIG. 2) where the coupled-mode region of the transmit coil 214 (FIG. 2) may be more powerful.

As stated, efficient transfer of energy between the transmitter 104 and receiver 108 may occur during matched or nearly matched resonance between the transmitter 104 and the receiver 108. However, even when resonance between the transmitter 104 and receiver 108 are not matched, energy may be transferred, although the efficiency may be affected. Transfer of energy occurs by coupling energy from the field 105 of the transmitting coil to the receiving coil residing in the neighborhood where this field 105 is established rather than propagating the energy from the transmitting coil into free space.

The resonant frequency of the loop or magnetic coils is based on the inductance and capacitance. Inductance may be simply the inductance created by the coil 352, whereas, capacitance may be added to the coil's inductance to create a resonant structure at a desired resonant frequency. As an example, capacitor 354 and capacitor 356 may be added to the transmit or receive circuitry 350 to create a resonant circuit that selects a signal 358 at a resonant frequency. Accordingly, for larger diameter coils, the size of capacitance needed to sustain resonance may decrease as the diameter or inductance of the loop increases. Furthermore, as the diameter of the coil increases, the efficient energy transfer area of the near-field may increase. Other resonant circuits formed using other components are also possible. As another example, a capacitor may be placed in parallel between the two terminals of the coil 352.

In one embodiment, the transmitter 104 may be configured to output a time varying magnetic field with a frequency corresponding to the resonant frequency of the transmit coil 114. When the receiver is within the field 105, the time varying magnetic field may induce a current in the receive coil 118. As described above, if the receive coil 118 is configured to be resonant at the frequency of the transmit coil 118, energy may be efficiently transferred. The AC signal induced in the receive coil 118 may be rectified as described above to produce a DC signal that may be provided to charge or to power a load.

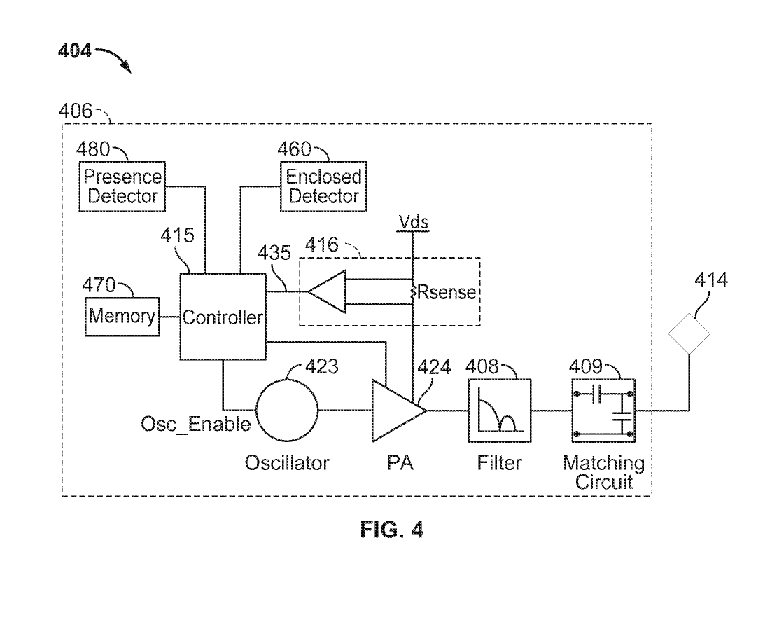

FIG. 4 is a functional block diagram of a transmitter 404 that may be used in the wireless power transfer system of FIG. 1, in accordance with exemplary embodiments of the invention. The transmitter 404 may include transmit circuitry 406 and a transmit coil 414. The transmit coil 414 may be the coil 352 as shown in FIG. 3. Transmit circuitry 406 may provide RF power to the transmit coil 414 by providing an oscillating signal resulting in generation of energy (e.g., magnetic flux) about the transmit coil 414. Transmitter 404 may operate at any suitable frequency. By way of example, transmitter 404 may operate at the 6.78 or 13.56 MHz ISM band.

Transmit circuitry 406 may include a fixed impedance matching circuit 409 for matching the impedance of the transmit circuitry 406 (e.g., 50 ohms) to the transmit coil 414 and a low pass filter (LPF) 408 configured to reduce harmonic emissions to levels to prevent self-jamming of devices coupled to receivers 108 (FIG. 1). Other exemplary embodiments may include different filter topologies, including but not limited to, notch filters that attenuate specific frequencies while passing others and may include an adaptive impedance match, that may be varied based on measurable transmit metrics, such as output power to the coil 414 or DC current drawn by the driver circuit 424. Transmit circuitry 406 further includes a driver circuit 424 configured to drive an RF signal as determined by an oscillator 423. The transmit circuitry 406 may be comprised of discrete devices or circuits, or alternately, may be comprised of an integrated assembly. An exemplary RF power output from transmit coil 414 may be on the order of 2.5 Watts.

Transmit circuitry 406 may further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 may also be referred to herein as processor 415. Adjustment of oscillator phase and related circuitry in the transmission path may allow for reduction of out of band emissions, especially when transitioning from one frequency to another.

The transmit circuitry 406 may further include a load sensing circuit 416 for detecting the presence or absence of active receivers in the vicinity of the near-field generated by transmit coil 414. By way of example, a load sensing circuit 416 monitors the current flowing to the driver circuit 424, that may be affected by the presence or absence of active receivers in the vicinity of the field generated by transmit coil 414 as will be further described below. Detection of changes to the loading on the driver circuit 424 are monitored by controller 415 for use in determining whether to enable the oscillator 423 for transmitting energy and to communicate with an active receiver. As described more fully below, a current measured at the driver circuit 424 may be used to determine whether an invalid device is positioned within a wireless power transfer region of the transmitter 404.

The transmit coil 414 may be implemented with a Litz wire or as an antenna strip with the thickness, width and metal type selected to keep resistive losses low. In a one implementation, the transmit coil 414 may generally be configured for association with a larger structure such as a table, mat, lamp or other less portable configuration. Accordingly, the transmit coil 414 generally may not need “turns” in order to be of a practical dimension. An exemplary implementation of a transmit coil 414 may be “electrically small” (i.e., fraction of the wavelength) and tuned to resonate at lower usable frequencies by using capacitors to define the resonant frequency.

The transmitter 404 may gather and track information about the whereabouts and status of receiver devices that may be associated with the transmitter 404. Thus, the transmit circuitry 406 may include a presence detector 480, an enclosed detector 460, or a combination thereof, connected to the controller 415 (also referred to as a processor herein). The controller 415 may adjust an amount of power delivered by the driver circuit 424 in response to presence signals from the presence detector 480 and the enclosed detector 460. The transmitter 404 may receive power through a number of power sources, such as, for example, an AC-DC converter (not shown) to convert conventional AC power present in a building, a DC-DC converter (not shown) to convert a conventional DC power source to a voltage suitable for the transmitter 404, or directly from a conventional DC power source (not shown).

As an example, the presence detector 480 may be a motion detector utilized to sense the initial presence of a device to be charged that is inserted into the coverage area of the transmitter 404. After detection, the transmitter 404 may be turned on and the RF power received by the device may be used to toggle a switch on the Rx device in a pre-determined manner, which in turn results in changes to the driving point impedance of the transmitter 404.

As another example, the presence detector 480 may be a detector capable of detecting a human, for example, by infrared detection, motion detection, or other suitable means. In some exemplary embodiments, there may be regulations limiting the amount of power that a transmit coil 414 may transmit at a specific frequency. In some cases, these regulations are meant to protect humans from electromagnetic radiation. However, there may be environments where a transmit coil 414 is placed in areas not occupied by humans, or occupied infrequently by humans, such as, for example, garages, factory floors, shops, and the like. If these environments are free from humans, it may be permissible to increase the power output of the transmit coil 414 above the normal power restrictions regulations. In other words, the controller 415 may adjust the power output of the transmit coil 414 to a regulatory level or lower in response to human presence and adjust the power output of the transmit coil 414 to a level above the regulatory level when a human is outside a regulatory distance from the electromagnetic field of the transmit coil 414.

As an example, the enclosed detector 460 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 404 does not remain on indefinitely may be used. In this case, the transmitter 404 may be programmed to shut off after a user-determined amount of time. This feature prevents the transmitter 404, notably the driver circuit 424, from running long after the wireless devices in its perimeter are fully charged. This event may be due to the failure of the circuit to detect the signal sent from either the repeater or the receive coil that a device is fully charged. To prevent the transmitter 404 from automatically shutting down if another device is placed in its perimeter, the transmitter 404 automatic shut off feature may be activated only after a set period of lack of motion detected in its perimeter. The user may be able to determine the inactivity time interval, and change it as desired. As an example, the time interval may be longer than that needed to fully charge a specific type of wireless device under the assumption of the device being initially fully discharged.

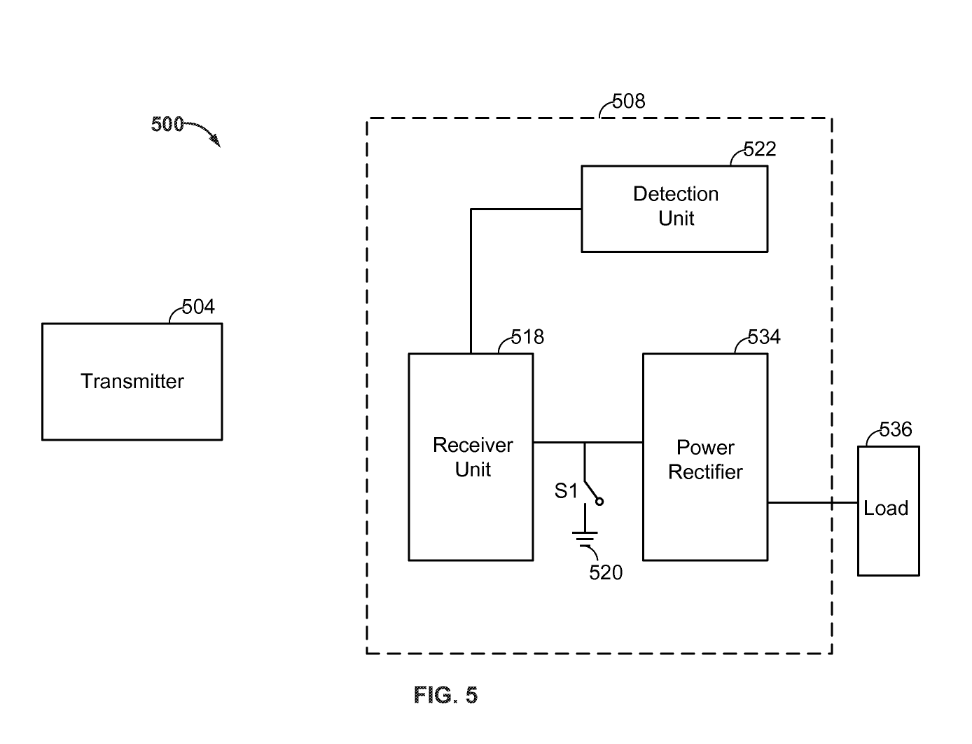

FIG. 5 illustrates an example wireless power transfer system 500 including a transmitter 504 and a receiver 508. Receiver 508 includes a receiver unit 518, a power rectifier 534, and a forward link detection unit 522. The forward link detection unit 522 may be configured to detect a signal (i.e., a transmit signal) transmitted from the transmitter 504. Receiver unit 518 may be operably coupled to forward link detection unit 522 and a load 536 may be coupled to receiver 508. Furthermore, receiver unit 518 may be coupled to power rectifier 534. Receiver 508 may also include a switch S1, which may comprise any suitable switching element, such as a transistor. Switch S1 may be configured to selectively couple a node A to a ground voltage 520. Although switch S1 is illustrated as being positioned between receiver unit 518 and power rectifier 534, switch S1 may be located in any suitable position, such as between power rectifier 534 and load 536. Moreover, although power rectifier 534 and load 536 are illustrated in FIG. 5 as separate elements, the term “load” as used herein may include the power rectifier 534.

System 500 may include a transmitter 504 configured to wirelessly transmit power within an associated near field region. The transmitter 504 may further be configured to receive a reverse link signal from the receiver 508 when the receiver modifies the state of switch S1 to change or modulate an impedance or load detected by transmitter 504. The coil within transmitter 504 and a coil within receiver unit 518 may be tuned with one another to enable for efficient wireless transfer between transmitter 504 and receiver 508. Accordingly, transmitter 504 may also be referred to as a “series tuned transmitter.” Similarly, receiver unit 518 may also be referred to as a “series tuned receiver.” Transmitter 504 and receiver unit 518 may be commonly referred to as “series tuned transceiver system.”

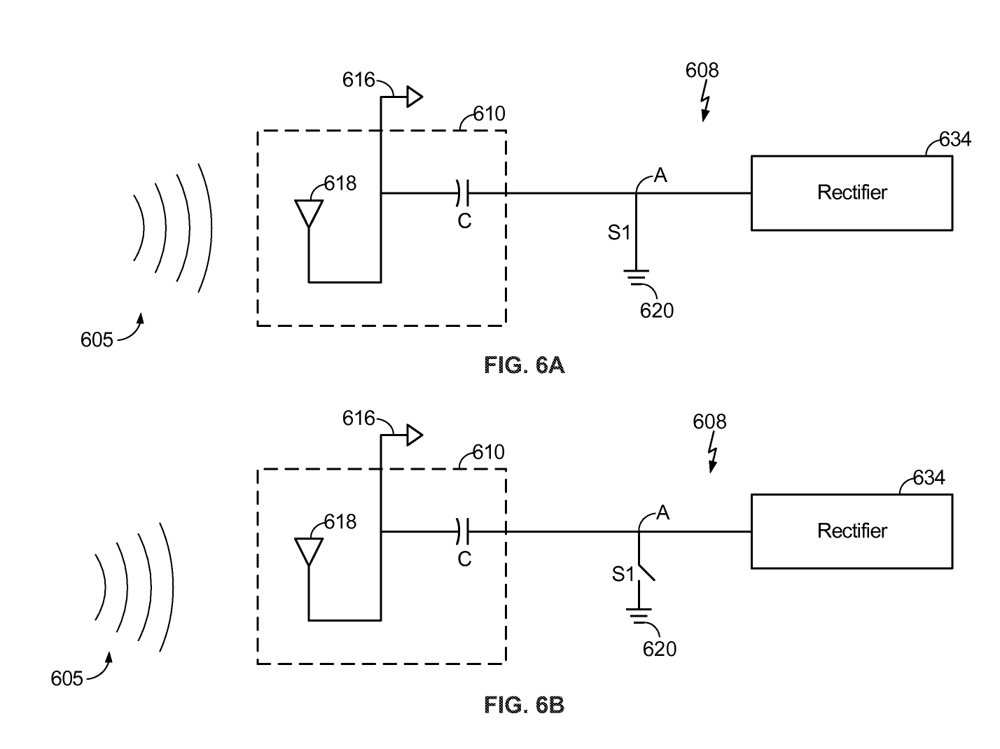

FIGS. 6A and 6B illustrate schematics of a portion of receiver 608 in various states to illustrate reverse-link signaling from receiver 608 to an associated transmitter (e.g., transmitter 504 of FIG. 5). With reference to FIG. 6A, switch S1 is closed and, therefore, node A is coupled to ground voltage 620. With reference to FIG. 6B, switch S2 is open, thus, node A is decoupled from ground voltage 620. In comparison to an impedance as seen by transmitter 504 (see FIG. 5) when node A is coupled to a ground voltage, an impedance as seen by transmitter 504 may be lower when node A is decoupled from the ground voltage. Stated another way, an impedance as seen by a transmitter in communication with a receiver in the configuration of FIG. 6B may be lower than an impedance as seen by a transmitter in communication with a receiver in the configuration of FIG. 6A. Stated yet another way, as a load associated with a receiver may increase, an impedance may decrease as seen by a transmitter in communication with the receiver. Similarly, as a load of a receiver decreases, the impedance as seen by the transmitter may increase.

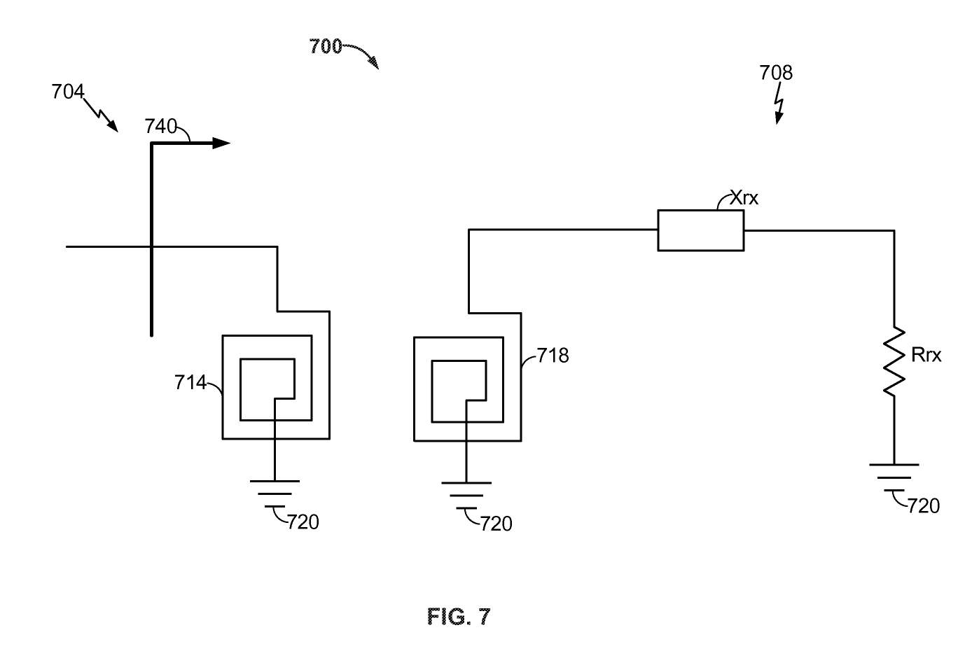

FIG. 7 illustrates a system 700 including portion of a transmitter 704 including transmitter coil 714 and a portion of a receiver 708 including a receiver coil 718. Receiver 708 further includes an imaginary load Xᵣₓ and a real load Rᵣₓ. An impedance Zₜₓ, which is illustrated by arrow 740, as seen by transmitter 704 and associated with receiver 708 may be given by Equation 1 below.

$${Z}_{tx} = \frac{{w}^{2} {M}_{12}^{2} {R}_{rx}}{{R}_{rx}^{2} + {( {wM}_{22} + {X}_{rx} )}^{2}} + j [ {wM}_{11} - \frac{{w}^{2} {M}_{12}^{2} ( {wM}_{22} + {X}_{rx} )}{{R}_{rx}^{2} + {( {wM}_{22} + {X}_{rx} )}^{2}} ] \qquad Equation 1$$

where Zₜₓ is the impedance looking into the transmitting coil, ω is the frequency in radians, M₁₁ is the self inductance of transmitting coil 714, M₂₂ is the self inductance of receiving coil 718, M₁₂ is the mutual inductance between transmitting coil 714 and receiving coil 718, Rᵣₓ is the real load of the receiver, and Xᵣₓ is the imaginary load of the receiver.

Furthermore, if transmitter coil 714 and receiver coil 718 are tuned with one another, as previously noted, the impedance Zₜₓ as seen by transmitter 704 and associated with receiver 708 may be given by Equation 2 below.

$${Z}_{tx} = \frac{{ω}^{2} {M}_{12}^{2}}{{R}_{rx}} \qquad Equation 2$$

With reference to FIGS. 5-7 and Equation 2, the impedance Zₜₓ as seen by a transmitter and associated with a receiver may be minimized by maximizing the real load of the receiver Rᵣₓ, and the impedance Zₜₓ may be maximized by minimizing the real load of the receiver Rᵣₓ.

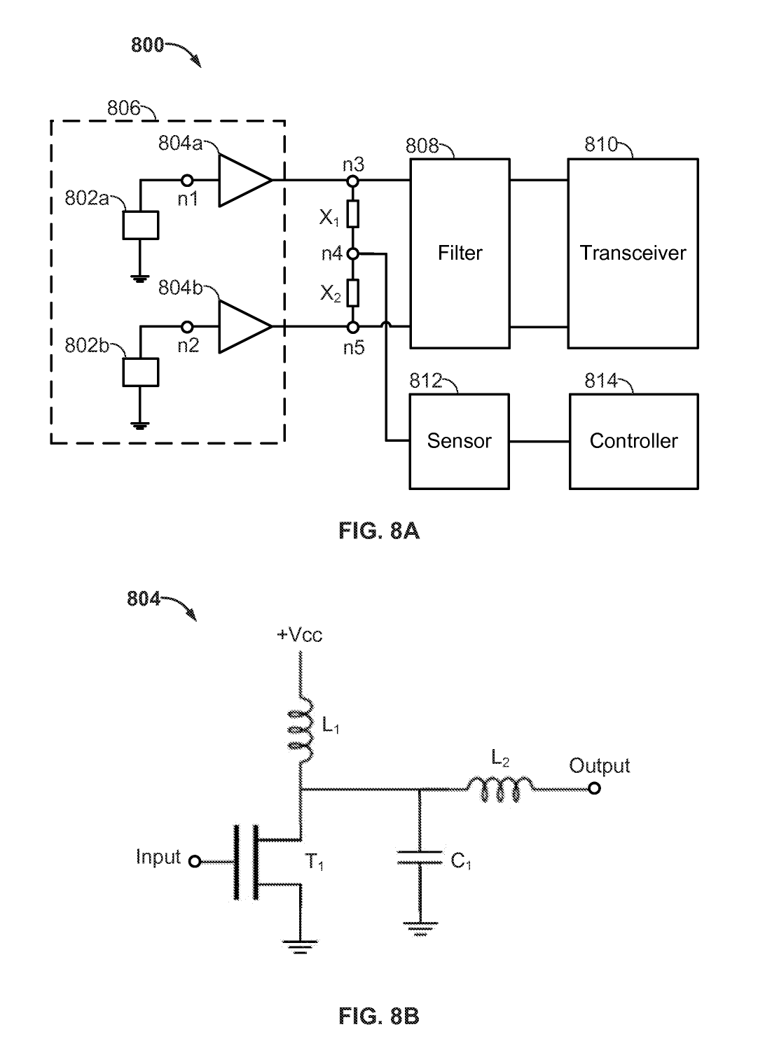

FIG. 8A is a functional block diagram of an example transmitter 800. The transmitter 800 includes a first gate driver 802a, a second gate driver 802b, a first transmitter driver 804a, a second transmitter driver 804b, a first impedance X₁, a second impedance X₂, a filter 808, a transceiver 810, a sensor 812, and a controller 814. A node n1 is located at the connection between the output of the first gate driver 802a and the input of the first transmitter driver 804a, and a node n2 is located at the connection between the output of the second gate driver 802b and the input of the second transmitter driver 804b. Nodes n3 and n5 are located at the outputs of the first transmitter driver 804a and the second transmitter driver 804b, respectively. A node n4 is located at the connection between the first impedance X₁ and the second impedance X₂ and is connected to the input of sensor 812. The output of sensor 812 is connected to the input of controller 814. Further, although not shown, controller 814 may be connected to one or more of the components of transmitter 800 so that controller 814 may control the functioning of the one or more components.

In combination, the first gate driver 802a, the second gate driver 802b, the first transmitter driver 804a, and the second transmitter driver 804b may form a push-pull driver 806. The first gate driver 802a and the second gate driver 802b may each be configured to provide a gate voltage equal in magnitude and 180° out of phase relative to each other at nodes n1 and n2, respectively, so that the output signals from the first gate driver 802a and the second gate driver 802b are out of phase with each other. The opposite ends of the first gate driver 802a and the second gate driver 802b may be coupled to direct current (DC) ground, as illustrated, or alternating current (AC) ground. The first transmitter driver 804a and the second transmitter driver 804b may be configured to amplify and/or increase the driving power of the received signal from the first gate driver 802a and the second gate driver 802b, respectively. Thus, the push-pull driver 806 may be configured to provide output voltages at nodes n3 and n5 that are equal in magnitude and 180° out of phase relative to each other so that the signals at nodes n3 and n5 are out of phase with each other.

The output signal from the push-pull driver 806 may be coupled to a filter 808. In some aspects, the filter 808 may include a low-pass filter. In some aspects, the filter 808 may include one or more high-pass, band-pass, or low-pass filters.

The output signal from the filter 808 may be coupled to a transceiver 810. In some aspects, the transceiver 810 includes a transmit coil. The transceiver 810 may be configured to wirelessly communicate with a receiver coil of another device based on the received output signal from the filter 808. In some aspects, a coil of the transceiver 810 may wirelessly transmit power to the receiver coil for powering or charging a load connected to the receiver coil. Further, the transceiver 810 may be configured to wirelessly receive reverse link signals from the receiver coil, such as signals by a change of the input impedance the receiver coil.

The first impedance X₁ and the second impedance X₂ may be connected in series with each other and together connected in parallel with the push-pull driver 806, the filter 808, and/or the transceiver 810. As illustrated in FIG. 8A, the first impedance X₁ and the second impedance X₂ is coupled in parallel between the push-pull driver 806 and the filter 808. In some aspects, the first impedance X₁ and the second impedance X₂ may be coupled in parallel between the filter 808 and the transceiver 810. The first impedance X₁ and second impedance X₂ may include combinations of resistors, inductors, or capacitors, for example. The impedance of the first impedance X₁ may advantageously equal the impedance of the second impedance X₂, resulting in a virtual AC ground at the node n4. As one example, the first impedance X₁ and the second impedance X₂ may each be resistors having a resistance of 10 kΩ.

In some aspects, the node n4 between the first impedance X₁ and the second impedance X₂ may be a virtual AC ground in the circuit of transmitter 800. A virtual AC ground node may denote a node where the AC contribution of the signals from the first transmitter driver 804a and the second transmitter driver 804b sum such that the AC signal at node n4 equals zero. That is, for instance, the signals from the first transmitter driver 804a and the second transmitter driver 804b sum such that the signal at node n4 may maintain a constant average voltage with no AC voltage component. In some aspects, the AC voltage component may be minimal or negligible (e.g., relative to a direct current component). Further, node n4 may not be connected to DC ground.

The sensor 812 may be configured to measure or sense changes or shifts in the voltage, such as the average voltage, at node n4. The shift in voltage may be representative of a change of an input impedance of the receiver coil while transceiver 810 communicates with the receiver coil. For example, when a receiver coil modulates the load coupled to the receiver coil while the receiver coil is receiving power, the average voltage at node n4 may decrease or increase. Accordingly, the sensor 812 may be configured to sense the decrease or increase in the average voltage at node n4 and thereby receive a reverse link signal from a receiver coil.

FIG. 8B is an example transmitter driver 804 circuit schematic. The transmitter driver 804 illustrates one Class E switch-mode amplifier design for the transmitter drivers 804a, 804b of FIG. 8A.

The transmitter driver 804 may include a transistor T₁, capacitor C₁, and inductors L₁, L₂. The gate of transistor T₁ may provide an input to transmitter driver 804. Either the drain or source of transistor T₁ may be connected to DC ground, as illustrated, or AC ground. The drain or source of transistor T₁ that is not connected to a ground may be connected to capacitor C₁ and inductors L₁, L₂. The lead of capacitor C₁ that is not connected to transistor T₁ may be connected to DC ground, as illustrated, or AC ground. The lead of inductor L₁ that is not connected to transistor T₁ may be connected to a power supply voltage +V_{cc}. The lead of inductor L₂ that is not connected to transistor T₁ may provide the output for the transmitter driver 804. In some aspects, inductor L₁ has an inductance that is approximately 100 times greater than the inductance of inductor L₂.

In one aspect, transmitter drivers 804a, 804b of FIG. 8A each include the circuit of transmitter driver 804. This is, the input and output of one transmitter driver 804 may be connected to nodes n1 and n3 of FIG. 8A, respectively, and the input and output of a second transmitter driver 804 may be connected to nodes n2 and n5 of FIG. 8A, respectively. The gate of each transistor T₁ may receive an input signal from the first gate driver 802a or second gate driver 802b and drive output currents from the power supply voltage +Vcc through inductors L₁, L₂.

Further, when transmitter 800 of FIG. 8A receives a reverse link signal from a receiver, the voltage at node n4 may change due to current-limiting effects of inductor L₁. In particular, an increased input impedance of the receiver coil may cause transceiver 810 to draw additional current through inductor L₂. However, the rate of change of current that can be supplied to transceiver 810 from transmitter drivers 804a, 804b may be limited by inductor L₁. As a result, the output voltages of transmitter drivers 804a, 804b at nodes n3 and n5 may decrease, causing a momentary shift in average voltage at node n4. The sensor 812 may sense the change in voltage at node n4. The sensed change in voltage or a signal indicative of the sensed change in voltage may be transmitted from sensor 812 to a controller 814. The controller 814 may process the sensed change in voltage or signal indicative of the sensed change in voltage to receive information from the receiver.

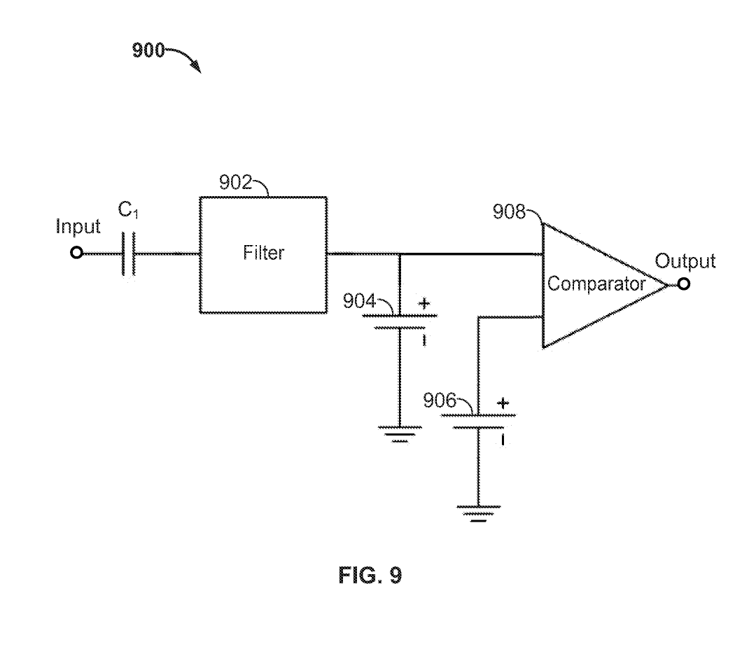

FIG. 9 is a functional block diagram of an example sensor 900, such as the sensor 812 of FIG. 8A. The sensor 900 may include an isolation capacitor C₁, a filter 902, a bias voltage 904, a reference voltage 906, and a comparator 908. The input of the isolation capacitor C₁ may provide an input node for the sensor 900, and the output of the isolation capacitor C₁ may be electrically coupled to the filter 902. The output of the filter 902 may be electrically coupled to the bias voltage 904 and a first input of the comparator 908. The reference voltage 906 may be electrically coupled to a second input of the comparator 908. The bias voltage 904 and the reference voltage 906 may be designed or selected such that the comparator 908 may have a first voltage at the output node when the output node maintains a constant average voltage. The output of the comparator 908 may provide an output node for the sensor 900.

The input node of the sensor 900 may be electrically coupled to node n4 of FIG. 8A so that the load modulation sensor 900 may sense changes in voltage at node n4, such as changes caused by reverse link signaling. When the isolation capacitor C₁ may experience an increase or a decrease in average voltage at node n4, the change in average voltage may pass through the filter 902 and result in an increase or a decrease in voltage at the first input of the comparator 908. Consequently, the comparator 908 may sense a change in voltage at the first input relative to the second input, and the comparator 908 may change the output node of the sensor 900 from the first voltage to a second voltage.

The voltage of the output node of the sensor 900 may be transmitted to a controller, such as controller 814 of FIG. 8A. The controller may determine based on the voltage at the output node whether a transmitter, such as transmitter 800 of FIG. 8A, received a reverse link signal. In some aspects, if a reverse link signal may be received, the controller may cause transmitter to stop communicating with or charging a receiver. For example, after receiving a reverse link signal, the controller may be configured to cause the push-pull driver 806 to stop generating or transmitting a signal to the transceiver 810. Further, after receiving a reverse link signal, the controller may be configured to cause transceiver 810 to stop receiving or transmitting the signal.

The controller may be configured to receive information or communications from the receiver via sensed modulation of a load at the receiver. For example, one or more sensed voltage pulses or durations of voltage pulses at the transmitter may correspond to bits (e.g., 0 or 1) or values (e.g., three long consecutive pulses may indicate to stop charging a power receiving device). The controller may be configured to process the voltage pulses and/or durations and thereby determine to perform functions, such as controlling the transmitter 800 of FIG. 8A, based on the extracted information. Further, in some aspects, the controller may be configured to extract data from the sensed voltage shifts for various near field communications applications. For instance, a wireless mobile phone charger may receive identification information via a reverse link signal from a cell phone that the charger is charging. In some aspects, additionally or alternatively, other communication encoding and decoding approaches may be used to transmit information via reverse link signaling from the receiver to the transmitter.

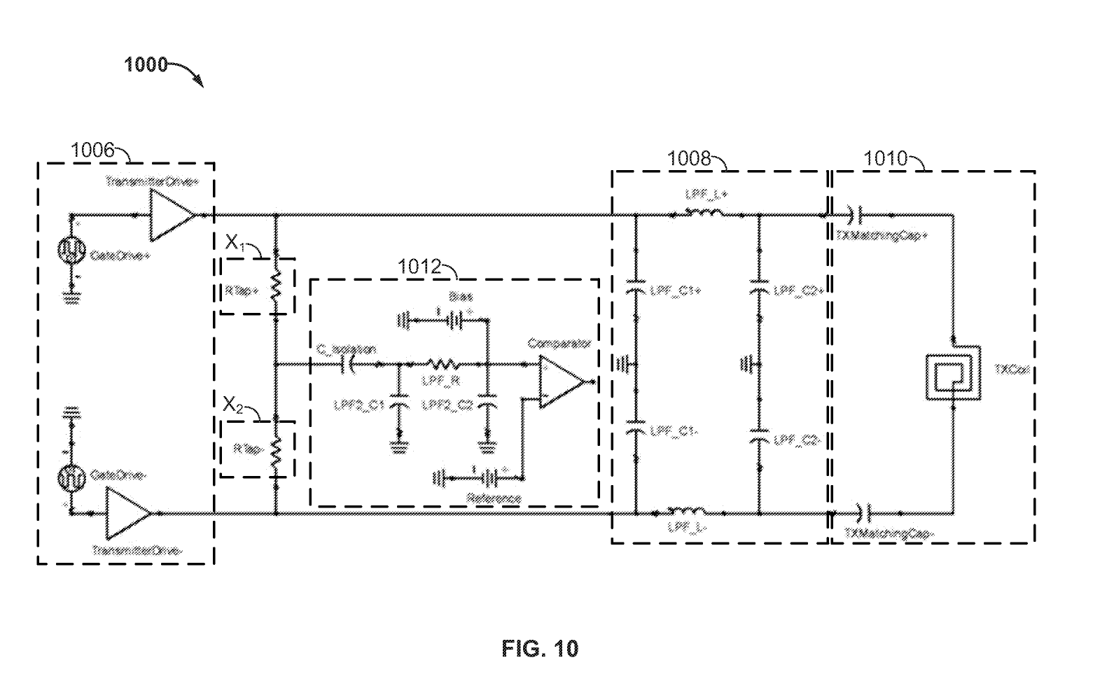

FIG. 10 is an example transmitter and sensor 1000 circuit schematic. FIG. 10 shows one example set of components and arrangement for the transmitter 800 of FIG. 8A and the sensor 900 of FIG. 9. The push-pull driver circuit 1006 may correspond to the push-pull driver circuit 806 of FIG. 8A. The filter 1008 may correspond to the filter 808 of FIG. 8A. The transceiver 1010 may correspond to the transceiver 810 of FIG. 8A. The impedances X₁ and X₂ may correspond to the first impedance X₁ and second impedance X₂ of FIG. 8A, respectively. The sensor 1012 may correspond to the sensor 900 of FIG. 9.

The transmitter and sensor designs of FIGS. 8A, 8B, 9, and 10 may provide many advantageous features. For example, the designs of FIGS. 8A, 8B, 9, and 10 may avoid the use of diodes or multi-stage filters that may be used with other types of detection circuits, such as those used in some envelope detection circuits. In some aspects, diodes and multi-stage filters may have parasitic effects or generate ringing in signal waveforms. Advantageously, reduced parasitic effects or ringing in signal waveforms may enable use of shorter guard intervals when inter-pulse interferences are an issue. Moreover, reduced parasitic effects or ringing in signal waveforms may permit increased data transfer rates and higher data transfer reliability.

As another example, the designs of FIGS. 8A, 8B, 9, and 10 may advantageously permit faster sensing of load modulation over other techniques, such as by detecting changes in the currents of transmitter circuitry. Faster sensing may enable receivers to successfully signal using shorter duration signals, and thereby increase receiver efficiency during signaling and minimize possible thermal issues from reverse link signaling.

As a further example, the designs of FIGS. 8A, 8B, 9, and 10 may permit detection of reverse link signaling at a single node of a transmitter circuit. Other sensing techniques may instead sense at two or more nodes to ensure balanced loading of a transmitter circuit. Advantageously, sensing at fewer nodes may require fewer circuit components and smaller circuitry and may interfere less with functioning of the transmitter circuit.

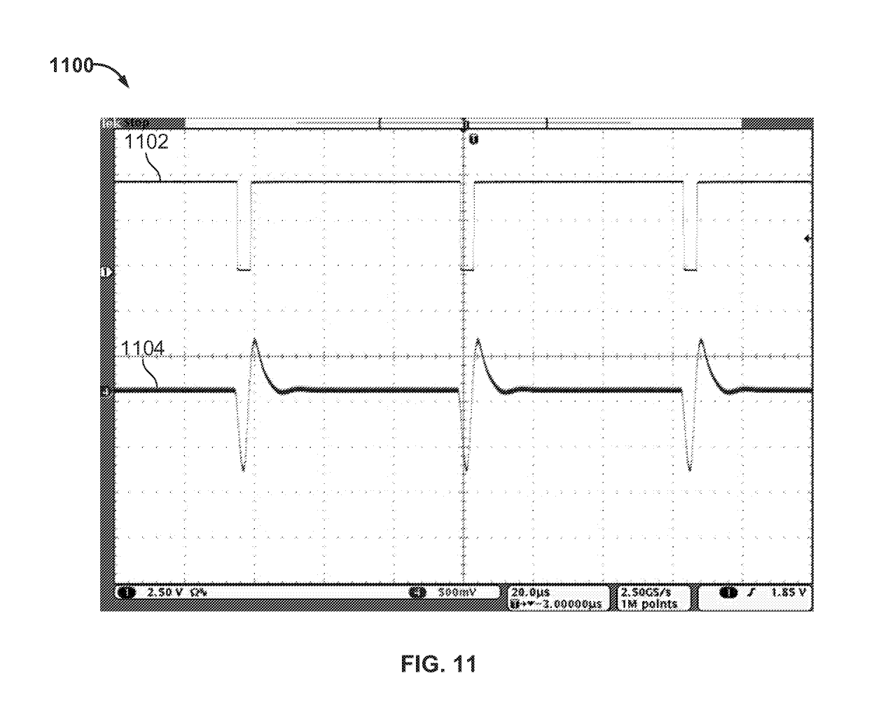

FIG. 11 is a graph 1100 illustrating voltages in an example transmitter and sensor circuit. The line 1102 illustrates the voltage versus time for an example output of a comparator, such as the comparator 908 of FIG. 9. The line 1104 illustrates the voltage versus time for an example virtual AC ground node of a transmitter, such as the node n4 of FIG. 8A. The lines 1102, 1004 illustrate that as the voltage at the virtual AC ground node shifts from a stable or average voltage, the comparator may sense the shift and switch its output voltage from a first voltage to a second voltage.

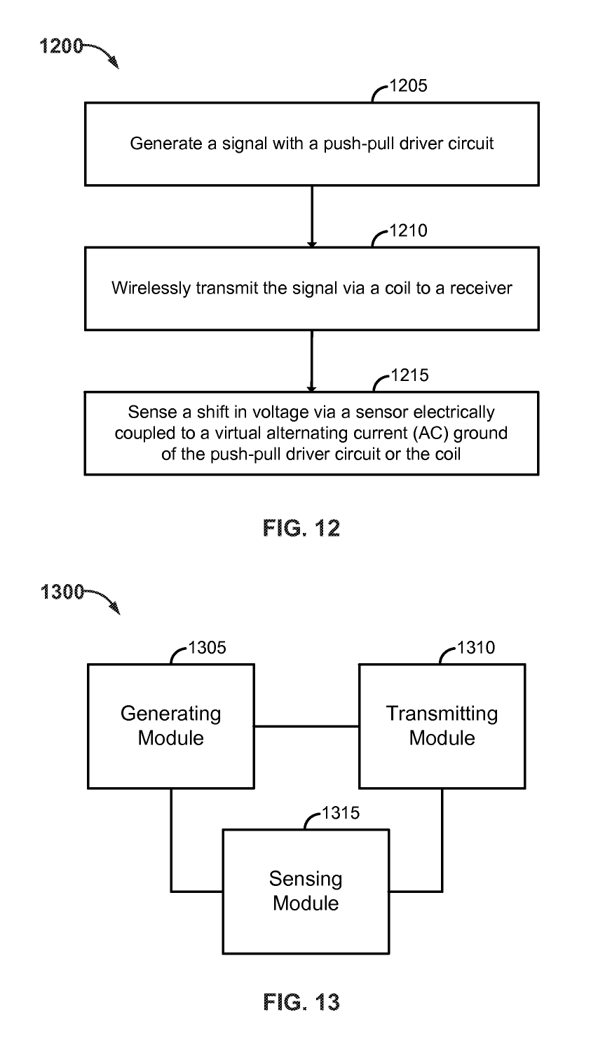

FIG. 12 is a flowchart of an example method 1200 of sensing reverse link signaling. The method 1200 may be performed using the transmitter 204 of FIG. 2, the transmitter 800 and sensor 900 of FIGS. 8A and 9, or the transmitter and sensor 1000 of FIG. 10, for example. Although the method 1200 is described below with respect to the elements of transmitter 800 of FIG. 8A and the sensor 900 of FIG. 9, other components may be used to implement one or more of the steps described herein.

At block 1205, a push-pull driver circuit may generate a signal. The push-pull driver circuit may comprise the push-pull driver 806, for example.

At block 1210, a coil may be configured to receive the signal from the push-pull driver circuit and wirelessly transmit the signal to a receiver. In some aspects, the coil may be configured to transmit an output signal based on the received signal. The coil may comprise the coil of transceiver 810, for example.

At block 1215, a sensor may be electrically coupled to a virtual alternating current (AC) ground of the push-pull driver circuit or the coil. The sensor may be configured to sense a shift in voltage at the virtual AC ground, where the shift in voltage may be representative of a change of an input impedance of the receiver. The sensor may comprise the sensor 900, for example.

FIG. 13 is a functional block diagram of a wireless transmitter 1300 configured to sense reverse link signaling. The wireless transmitter 1300 may include a generating module 1305 configured to generate a signal with a push-pull driver circuit. The generating module 1305 may be configured to perform one or more of the functions discussed with respect to block 1205 of FIG. 12. The generating module 1305 may correspond to the push-pull driver 806 of FIG. 8A. The wireless transmitter 1300 may further include a transmitting module 1310. The transmitting module 1310 may be configured to receive the signal from the generating module 1305 and wirelessly transmit the signal to a receiver. The transmitting module 1310 may be configured to perform one or more of the functions discussed with respect to block 1210 of FIG. 12. The transmitting module 1310 may correspond to the transceiver 810 of FIG. 8A. The wireless transmitter 1300 may further include a sensing module 1315. The sensing module 1315 may be configured to sense a shift in voltage at a virtual AC ground. The sensing module 1315 may be configured to perform one or more of the functions discussed above with respect to block 1215 of FIG. 12. The sensing module 1315 may correspond to the sensor 900 of FIG. 9.

Moreover, in one aspect, means for generating a signal may comprise the generating module 1305. In another aspect, means for wirelessly transmitting the signal to a receiver may comprise the transmitting module 1310. In yet another aspect, means for sensing a shift in voltage at a virtual AC ground may comprise the sensing module 1315.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments of the invention.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

Various modifications of the above described embodiments will be readily apparent, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus for wireless power transmission, comprising:
a push-pull driver circuit configured to generate a signal;
a coil electrically coupled to the push-pull driver circuit, the coil configured to receive the signal from the push-pull driver circuit and wirelessly transmit the signal to a receiver; and
a sensor electrically coupled to a virtual alternating current (AC) ground of the push-pull driver circuit or the coil, the sensor configured to sense a shift in voltage at the virtual AC ground, the shift in voltage representative of a change of an input impedance of the receiver.

2. The apparatus of claim 1, wherein the push-pull driver circuit comprises a switch-mode driver.

3. The apparatus of claim 2, wherein the push-pull driver circuit comprises a Class E switch-mode driver.

4. The apparatus of claim 1, wherein the sensor is configured to sense the shift in voltage by measuring a change in average voltage at the virtual AC ground.

5. The apparatus of claim 1, wherein the coil is configured to wirelessly transmit energy at a level sufficient to power or charge the receiver or a load coupled to the receiver.

6. The apparatus of claim 1, wherein the apparatus is configured to receive wireless communications from the receiver via an interaction by the receiver with a wireless power transfer field generated by the coil.

7. The apparatus of claim 1, further comprising a controller electrically coupled the sensor, the controller configured to:
receive a sensor signal from the sensor indicative of the sensed shift in voltage at the virtual AC ground, and
process the sensor signal.

8. The apparatus of claim 7, wherein the controller is further configured to cause the push-pull driver circuit to stop generating or transmitting the signal based on the sensor signal.

9. The apparatus of claim 7, wherein the controller is configured to cause the coil to stop receiving or wirelessly transmitting the signal based on the sensor signal.

10. The apparatus of claim 1, wherein the virtual AC ground is not connected to a direct current (DC) ground.

11. A method of wireless power transmission, comprising:
generating a signal with a push-pull driver circuit;
transmitting wirelessly with a coil the signal to a receiver; and
sensing with a sensor a shift in voltage at a virtual AC ground of the push-pull driver circuit or the coil, the shift in voltage representative of a change of an input impedance of the receiver.

12. The method of claim 11, wherein the push-pull driver circuit comprises a switch-mode driver.

13. The method of claim 12, wherein the push-pull driver circuit comprises a Class E switch-mode driver.

14. The method of claim 11, wherein sensing the shift in voltage at the virtual AC ground comprises measuring a change in average voltage at the virtual AC ground.

15. The method of claim 11, wherein the coil is configured to wirelessly transmit energy at a level sufficient to power or charge the receiver or a load coupled to the receiver.

16. The method of claim 11, further comprising receiving wireless communications from the receiver via an interaction by the receiver with a wireless power transfer field generated by the coil.

17. The method of claim 11, further comprising:
receiving a sensor signal indicative of the sensed shift in voltage at the virtual AC ground; and
processing the sensor signal.

18. The method of claim 17, further comprising causing the push-pull driver circuit to stop generating the signal based on the sensor signal.

19. The method of claim 17, further comprising causing the coil to stop wirelessly transmitting the signal based on the sensor signal.

20. The method of claim 11, wherein the virtual AC ground is not connected to a direct current (DC) ground.

21. An apparatus for wireless power transmission, comprising:
means for generating a signal;
means for transmitting wirelessly the signal to a receiver; and
means for sensing a shift in voltage at a virtual AC ground of the means for generating or the means for transmitting, the shift in voltage representative of a change of an input impedance of the receiver.

22. A non-transitory computer storage that stores executable program instructions that direct a wireless power transmitter to perform a process that comprises:
generating a signal with a push-pull driver circuit to cause a coil to wirelessly transmit the signal to a receiver; and
sensing with a sensor a shift in voltage at a virtual AC ground of the push-pull driver circuit or the coil, the shift in voltage representative of a change of an input impedance of the receiver.
